(19) United States
(12) Patent Application Publication
(10) Pub. No.: US 2004/0170883 A1
(43) Pub. Date: Sep. 2, 2004

(54) Fuel cell module

(76) Inventors: Willi Bartholomeyzik, Hassloch (DE); Gerhard Bohrmann, Bohl-Iggelheim (DE); Regina Volker, Worms (DE)

Correspondence Address: Herbert B. Keil, KEIL & WEINKAUF, 1350 Connecticut Ave., N.W., Washington, DC, 20036, US

(21) Appl. No.: 10/743,059

(22) Filed: Dec. 23, 2003

(30) Foreign Application Priority Data
Dec. 23, 2002 (DE) 102 61 482.2

(51) Int. Cl. H01M 2/08; H01M 8/04; H01M 8/02; B32B 31/00; H01M 8/10

(52) U.S. Cl. 429/36; 429/38; 429/32; 429/26; 156/272.8

(57) ABSTRACT

The invention relates to a fuel cell module (21, 22) for PEM fuel cell stacks comprising a bipolar plate (2) and a membrane-electrode assembly (MEA) (3), wherein the bipolar plate (2) includes a circumferential frame (5) made of an electrically nonconductive material and further includes an electrically conductive inner bipolar plate region (6) which is enclosed by the frame (5) and comprises channels for gases and, if required, for coolants, and wherein the MEA (3), which comprises a polymer-electrolyte membrane is fixed on the anode side to the frame (5) of the bipolar plate (2) by means of a weld or by a circumferential elastomer seal partially overlapping the MEA (3).

The present invention relates to a fuel cell module for polymer-electrolyte-membrane (PEM) fuel cell stacks which comprises a bipolar plate and a membrane-electrode assembly (MEA) and to a method of fabricating it.

The means of propulsion in motor vehicles hitherto have predominantly been internal combustion engines requiring petroleum products as the fuel. As petroleum resources are limited and the combustion products can have an adverse effect on the environment, research in recent years has increasingly been directed at alternative propulsion schemes.

The utilization of electrochemical fuel cells for mobile and stationary energy supply means is meeting increased interest in this context. Fuel cells are energy converters which convert chemical energy into electrical energy. The fuel cell inverts the electrolytic principle.

At present, various types of fuel cells exist, whose principle of operation is generally based on the electrochemical recombination of hydrogen and oxygen to give water as the end product. They can be categorized according to the type of the conductive electrolyte used, the operating temperature level and the achievable output ranges. Particularly suitable for use in motor vehicles are polymer-electrolyte-membrane fuel cells. They are usually operated at a temperature in the range from 50 to 90° C. As the voltage of an individual cell is far too low for practical applications, it is necessary for a plurality of such cells to be connected in series to form a fuel cell stack. At present, in a complete stack, PEM fuel cells usually supply electrical power in the range from 1 to 75 kW (cars) and up to 250 kW (utility vehicles, buses).

In a PEM fuel cell, the electrochemical reaction of hydrogen with oxygen to produce water is divided into the two substeps reduction and oxidation by the insertion of a proton-conducting membrane between the anode electrode and the cathode electrode. This entails a separation of charges which can be utilized as a voltage source. Such fuel cells are summarized, for example, in “Brennstoffzellen-Antrieb, innovative Antriebkonzepte, Komponenten und Rahmenbedingungen [Fuel Cell Propulsion, Innovative Propulsion Schemes, Components and Constraints]”, paper at the specialist conference of IIR Deutschland GmbH, May 29 to 31, 2000, Stuttgart.

An individual PEM fuel cell is of symmetric design. Arranged successively on both sides of a polymer membrane are one catalyst layer and one gas distribution layer each, followed by a bipolar plate. Current collectors are used to tap off the electrical voltage, while end plates ensure that the reactant gases are metered in, that the reaction products are removed and that compression-bonding and sealing arrangement are achieved.

In a fuel cell stack, a multiplicity of cells is stacked with respect to one another in an electrical series, being separated from one another by an impermeable, electrically conductive bipolar plate which is referred to as the bipolar plate. In such an arrangement, the bipolar plate bonds two cells mechanically and electrically. As the voltage of an individual cell is in the range around 1 V, practical applications require numerous cells to be connected in series. Often, up to 400 cells, separated by bipolar plates, are stacked on top of one another, the stacking arrangement of the cells being such that the oxygen side of the one cell is joined to the hydrogen side of the next cell via the bipolar plate. Here, the bipolar plate satisfies a number of functions. It serves for electrical interconnection of the cells, for supplying and distributing reactants (reactant gases) and coolant, and for separating the gas compartments. In this context, a bipolar plate must satisfy the following characteristics:

chemical resistance to humid oxidative and reductive conditions

gas tightness

high conductivity

low contact resistances

dimensional stability

low costs in terms of material and fabrication

no design restrictions

high stability under mechanical loads

corrosion resistance

low weight.

At present, three different types of bipolar plates are in use. Firstly, metal bipolar plates are employed which are composed, for example, of alloy steels or coated other materials such as aluminum or titanium.

Metallic materials are distinguished by high gas tightness, dimensional stability and high electrical conductivity.

Graphite bipolar plates can be given a suitable shape by compression-molding or milling. They are distinguished by chemical resistance and low contact resistances, but, in addition to high weight, have inadequate mechanical performance.

Composite materials are composed of special plastics which include conductive fillers, e.g. based on carbon.

WO 98/33224 describes bipolar plates made of ferrous alloys which include high proportions of chromium and nickel.

GB-A-2 326 017 discloses bipolar plates made of plastic material, which are rendered conductive by electroconductive fillers such as carbon powder. In addition, a superficial metal coating can be present which, via the edges of the bipolar plate, enables an electroconductive connection between two cells.

According to WO 98/53514, a polymer resin is treated by incorporating an electroconductive powder and a hydrophilizer. Polymer compounds filled with silicon dioxide particles and graphite powder are used as bipolar plates. In particular, phenol resins are used for this purpose.

As bipolar plates are critical functional elements of PEM fuel cell stacks, which make a considerable contribution to the costs and the weight of the stacks, there is great demand for bipolar plates which meet the abovementioned requirement profile and avoid the drawbacks of the known bipolar plates. In particular, uncomplicated and cost-effective fabrication of bipolar plates should be feasible.

An important problem in constructing fuel cell stacks is that of permanently sealing the anode compartment. Because of the high reactivity of hydrogen, this is necessary for safety reasons as well as for efficient energy utilization. U.S. Pat. No. 5,284,718, for example, discloses a method of sealing the gas compartments of PEM fuel cells which involves the laborious fabrication of seals made of elastomer and arranging them between the polymer-electrolyte membrane and the respective bipolar plate made of graphite.

A further gas-tight unit comprising a bipolar plate and a membrane-electrode assembly of PEM fuel cells disclosed by DE 198 29 142 A1. There, the free membrane edge, not covered by gas diffusion layers, of a membrane-electrode assembly is cemented gas-tightly to the bipolar plate. Said cementing is carried out, in particular, by means of a curable silicone and epoxy resin, the cement adhering to the membrane.

A further problem in the construction of fuel cell stacks is that the leak proofness of the individual fuel cells cannot be tested until the fuel cell stack has been assembled. This makes it more difficult to locate leaks.

A further problem with most systems is that there is the risk, with bipolar plates which are electrically conductive right up to their outer rim, that, after assembly into the fuel cell stack, the direct surface contact of the bipolar plates may, during operation of the stack, give rise to leakage currents or even short circuits.

A further problem arises when a multiplicity of individual cells are layered to form the stack is that of sealing the individual bipolar plates with respect to one another, said sealing usually entailing complex design and high cost.

To overcome these problems, a fuel cell module for PEM fuel cell stacks is proposed comprising a bipolar plate and a membrane-electrode assembly (MEA), wherein the bipolar plate includes a circumferential frame made of an electrically nonconductive material and further includes an electrically conductive inner bipolar plate region which is enclosed by the frame and comprises channels for gases and, if required, for coolants, and wherein the membrane-electrode assembly, which comprises a polymer-electrolyte membrane is fixed on the anode side to the frame of the bipolar plate by means of a weld or by a circumferential elastomer seal partially overlapping the MEA.

The assembly comprising polymer-electrolyte membrane and electrodes including the respective catalyst layers is referred to as a membrane-electrode assembly (MEA).

A fuel cell stack in this context is to be understood as a stack comprising at least two individual cells in each case separated by the bipolar plates. To fabricate a fuel cell stack, at least two fuel cells according to the invention are liked to one another. Between each pair of bipolar plates in the fuel cell stack an individual cell is present. At both ends, a stack has one electrically conductive electrode plate each instead of a bipolar plate.

The bipolar plate according to the invention includes a circumferential frame, made of an electrically nonconductive material, and an inner bipolar plate region enclosed by the frame. This design of the bipolar plate results in a separation of functions. The frame serves to at least define the supply channels and discharge channels contained therein for gas and coolants. Moreover, the fuel cell modules according to the invention can be linked to one another via the bipolar plate frames and be mounted in a housing, this having the advantage that no leakage currents or short circuits will occur between the bipolar plates. The inner bipolar plate region ensures electrical conductivity of the bipolar plate according to the invention. Moreover, on its surfaces it has channels for gases, the so-called flow-field, which distributes the gaseous reactants (e.g. hydrogen and oxygen) across the anode surface and cathode surface, respectively. In addition, the inner bipolar plate region includes integrated channels for coolants. The individual cells of a stack must be cooled as the power density increases. In many cases, straight air cooling is not sufficient, given the limited heat transfer. Liquid cooling, involving a cooling circuit comparable to an internal combustion engine, therefore becomes necessary. Cooling is consequently performed directly on the active cell face (inner bipolar plate region), thus ensuring direct heat transfer.

Gases and liquids are preferably fed to the inner bipolar plate region via channels in the frame of the bipolar plate and are discharged again via further channels in the frame.

The membrane-electrode assembly (MEA), in the fuel cell module according to the invention, is joined on the anode side to the frame of the bipolar plate by means of a weld or a circumferential elastomer seal partially overlapping the MEA. This has the advantageous result of permanently sealing the anode compartment. A further advantage is that a leak test can be carried out on each individual fuel cell module according to the invention, even before they are assembled to form the fuel cell stack. In particular, the especially critical anode-side hydrogen tightness of the bond between membrane and bipolar plate can be tested. This makes it considerably easier to locate leaks, compared with testing an entire fuel cell stack.

In the case of an elastomer seal partially overlapping the MEA there is the additional advantage that, when the individual fuel cell modules according to the invention are linked together, said elastomer seal serves to seal the individual bipolar plates with respect to one another. Consequently, no further laborious measures have to be taken to achieve said seal.

Suitable as a material for the elastomer seal is, in particular, a thermoplastic elastomer (TPE). At low temperatures, thermal plastic elastomers behave like a chemically crosslinked silicone or polyurethane (they are therefore resilient) and, at elevated temperatures, they can be hot-formed like a thermal plastic (plastically, as their physical crosslinks unlink at high temperatures and reform upon cooling).

The fuel cell modules according to the invention have the further advantage that they can be linked together cost-effectively to form a fuel cell stack, in addition considerably reducing the risk of the delicate polymer-electrolyte membrane being damaged during assembly (e.g. as a result of creasing), given that the polymer-electrolyte membrane is already fixed to the bipolar plate.

In a preferred embodiment of the present invention, the inner bipolar plate region includes metal sheets which have structures for the purpose of gas distribution and cooling. The metal sheets can comprise conductive corrosion-resistant metals or alloys. They can, for example, be steel sheets with an anti-corrosion coating. The structures required for gas distribution and cooling are preferably generated by the metal sheets being worked noncuttingly. Preferably, the inner bipolar plate region comprises two metal sheets on top of one another, in particular corrugated ones, in between which the coolant channels are configured and on which, on the cathode and anode side, respectively, the channels for the gas distribution are configured. The electrically conductive contact between the metal sheets in this arrangement can be achieved by suitable bonding techniques, e.g. pressing, welding or soldering.

In a preferred embodiment of the present invention, the inner bipolar plate region includes an electrically conductive polymer. This is either a polymer which is inherently electrically conductive or is electrically conductive by virtue of an electrically conductive material distributed therein, by virtue of a spray coating with metals which penetrates through openings in the polymer, or by virtue of an electrically conductive construction (e.g. comprising metal sheets or pins) enclosed by the polymer. For example, a plastic can be admixed, in order to enhance its conductivity, with a nonmetallic conductive substance and/or metal fibers or metal powder. One advantage of fabricating the inner bipolar plate region from a polymer is, for example, that the flow-field can be formed in any geometry, e.g. comprising meandrous channels. This can be achieved, for example, by the polymer being injection-molded.

In further embodiments of the present invention, the inner bipolar plate region comprises a material known from the prior art, e.g. graphite.

In a preferred embodiment of the present invention, the nonconductive material contained within the frame is an electrically nonconductive thermoplastic or thermosetting plastic, either of which may be reinforced. All those thermoplastic or thermosetting plastics can be used in the fabrication of the bipolar plate frame which are chemically stable under humid oxidizing and reductive conditions like those prevailing in PEM fuel cells. In addition, they should be gas-tight and dimensionally stable. Examples of suitable materials include polyphenylene sulfide (PPS), liquid crystal polyester (LCP), polyoxymethylene (POM), polyaryletherketone (PAEK), polyamide (PA), polybutylene terephthalate (PBT), polyphenylene oxide (PPO), polypropylene (PP) or polyethersulfone (PES), or other plastics employed industrially.

Preferably, the frame made of the nonconductive material is molded onto the inner bipolar plate region by means of injection molding. In a preferred embodiment of the present invention, the frame is integrally molded onto and around the inner bipolar plate region. Advantageously, this can be effected in a single operation. In particular, the frame can be fabricated in any geometry from a readily workable, low-cost mass-produced material by means of an injection-molding technique.

The present invention further relates to a method of fabricating a fuel cell module according to the invention, wherein the membrane-electrolyte assembly (MEA) is joined to the frame by means of a welding technique.

The welding technique employed to join the MEA to the frame is preferably laser welding. With laser welding, a bond by virtue of material between two or more components to be joined is achieved by heat being introduced by means of a laser beam. The laser beam passes through one laser beam-transparent component to be joined and impinges on an absorbing component to be joined. There the laser beam is converted into heat and causes plastification. The local increase in volume produced in the process gives rise to an areal contact with the transparent component to be joined, and, as a result of the heat conduction taking place, the transparent component to be joined is plastified likewise. This concludes the welding process of the two components to be joined, which are held in place by a positioning device. Possible procedural variants for laser transmission welding include, for example, a laser beam being passed along an outline to be welded, one of the options being robot control of the laser beam, or the defined alignment of a laser beam and a workpiece guided in accordance with the desired weld.

With the method according to the invention, selection of the materials is preferably such that the frame of the bipolar plate is laser beam-absorbent and the membrane-electrode assembly to be attached thereto is laser beam-transparent, at least in its edge zone.

Other possible welding techniques include e.g. ultrasonic welding or thermal contact welding.

In a preferred embodiment of the present invention, the membrane-electrode assembly has, in its edge zone, a rim which is made from the material of the polymer-electrolyte membrane and is joined to the frame by laser welding.

All the other layers of which the membrane-electrode assembly is composed and which comprise the electrodes and catalysts, occupy a smaller area in such an arrangement than the polymer-electrolyte membrane, which means that the polymer-electrolyte membrane projects beyond this area with its rim to be affixed by welding. In this embodiment, the PEM material is laser beam-transparent and laser-weldable in combination with the laser beam-absorbing frame material.

In this preferred embodiment of the present invention, the weld can be applied to the frame directly adjoining the inner bipolar plate region. The size chosen for the MEA therefore merely needs to be sufficient to essentially cover the frame to the extent of a weld width. Alternatively, however, it is possible for the weld to be applied in the outer edge zone of the frame, in which case the MEA or PEM must cover a suitably large proportion of (or possibly the entire) frame surface area.

After the MEA has been welded onto the frame of the bipolar plate, the fuel cell module according to the invention still has to be completed by means of seals on the cathode side which, in the assembled fuel cell stack, seal the bipolar plate frames with respect to one another. These seals are preferably elastomer seals which, once the frame has been finished, are molded onto the latter by means of injection molding.

The present invention further relates to a method of fabricating a fuel cell module according to the invention, wherein the elastomer seal molded onto the frame by an elastomer being injection-molded in such a manner that said elastomer seal is bonded to the frame by virtue of material or mechanically interlocked therewith and partially overlaps the MEA laid onto the frame. To this end, the bipolar plate, for example, is inserted together with the MEA into a suitable mold cavity, and the elastomer material is injected around them to produce the elastomer seal. Compatibility of the elastomer material with the frame material to achieve bonding by virtue of material is not absolutely necessary. Equally it is possible for mechanical interlocking to be achieved between the elastomer seal and the bipolar plate frame, for example by having suitably shaped grooves or openings in the frame which are likewise filled with the elastomer material and affix the seal to the frame.

The elastomer seal partially overlaps the MEA, thus affixing it to the frame, preferably without entering into a bond by virtue of material to the MEA, however. When a fuel cell stack is subsequently assembled, the respective elastomer seal is pressed against the corresponding MEA or PEM, a tight joint thus being achieved.

Preferably, the elastomer seal is injected onto the frame in its outer region, thus ensuring reliable positioning of the MEA. The MEA must overlap the frame to a correspondingly large degree.

Preferably, the elastomer seal mainly serves as a seal between two bipolar plates linked to one another in each case, wherein the frame of the one bipolar plate may have a circumferential groove which is sealingly engaged by the elastomer seal of the other bipolar plate.

Injection molding of the elastomer seal and possibly also of the frame and/or the inner bipolar plate region allows even complex geometrical shapes to be fabricated in a cost-effective and simple manner, also being suitable for mass production of the fuel cell module according to the invention.

The present invention further relates to a fuel cell stack comprising at least two fuel cell modules according to the invention, wherein the fuel cell modules are linked to one another via the frames and the fuel cell modules are sealed with respect to one another in a gas-tight manner via the elastomer seal and/or additional sealing elements disposed on the frames.

The fuel cell stacks according to the invention can be used, for example, to supply power in mobile and stationary facilities. Apart from domestic supplies, possible options include, in particular, power supplies of vehicles such as land vehicles, watercraft and aircraft as well as autarkic systems such as satellites.

The present invention is explained in more detail with reference to the drawing, in which

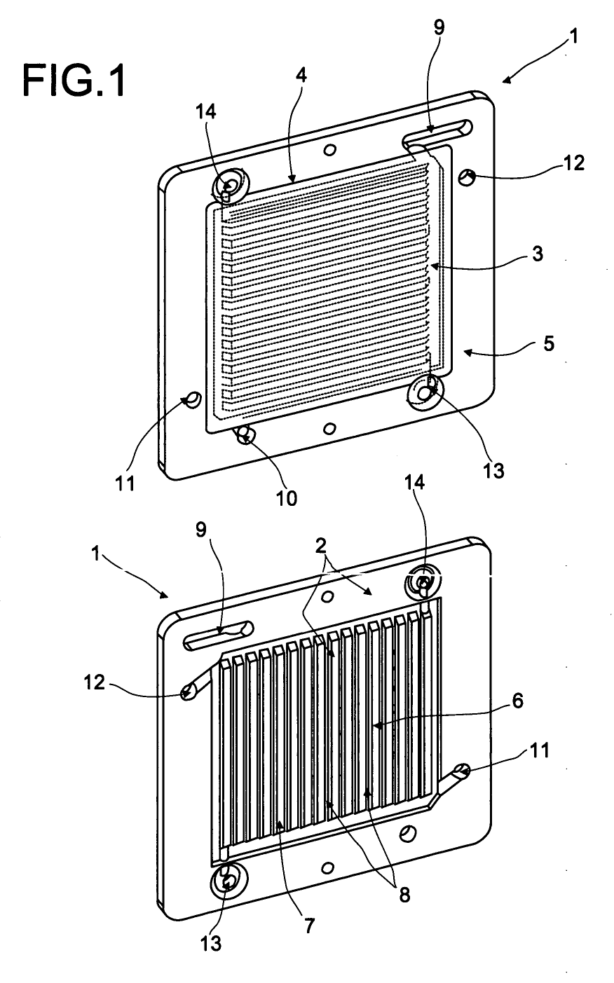

FIG. 1 shows the anode side and cathode side of a fuel cell module according to the invention with an MEA welded thereonto,

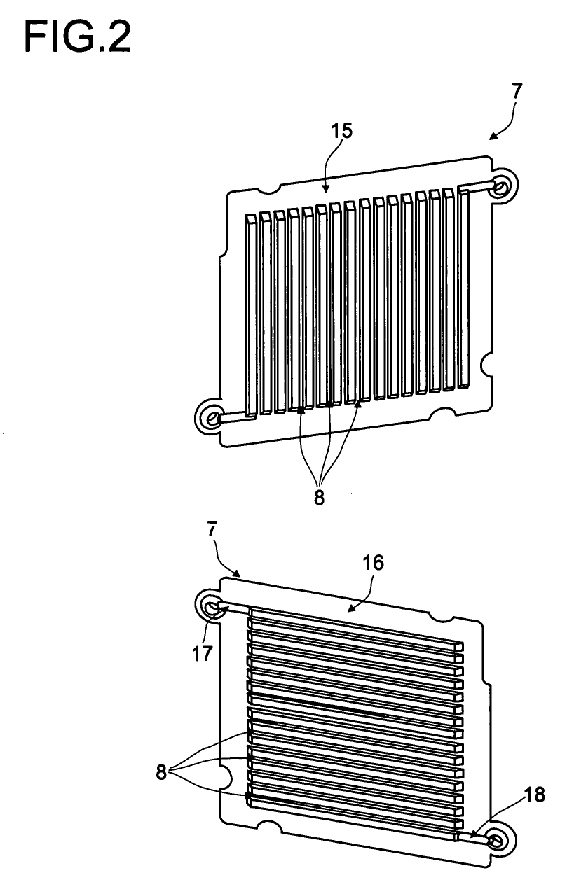

FIG. 2 shows metal sheets used in the inner bipolar plate region of a fuel cell module according to the invention,

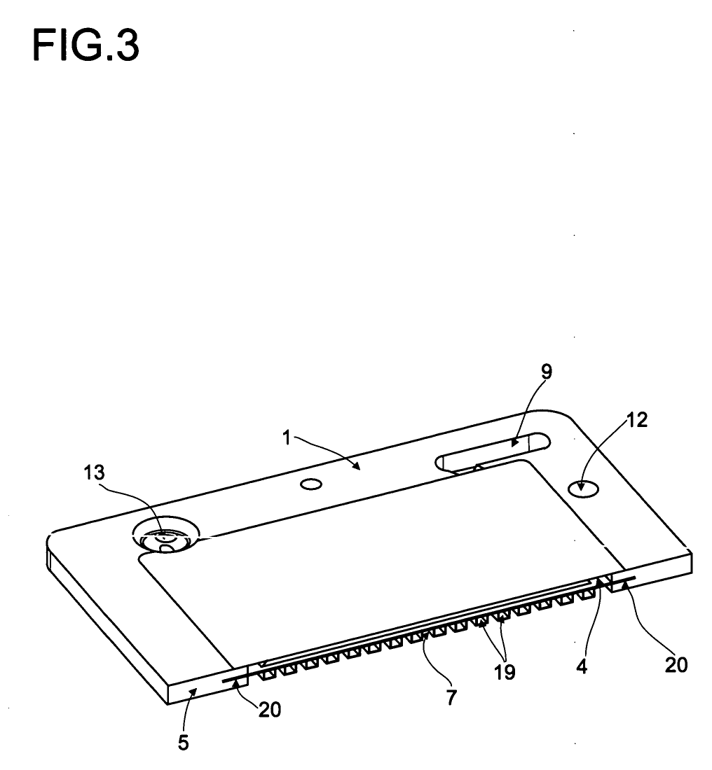

FIG. 3 shows the section through a fuel cell module according to the invention,

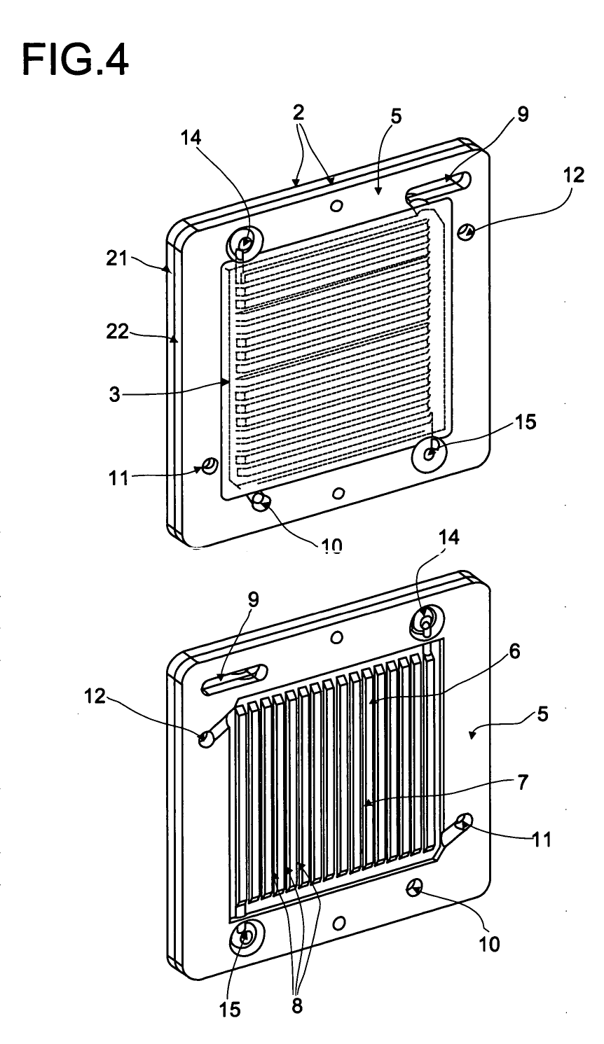

FIG. 4 shows part of a fuel cell stack according to the invention comprising two bipolar plates,

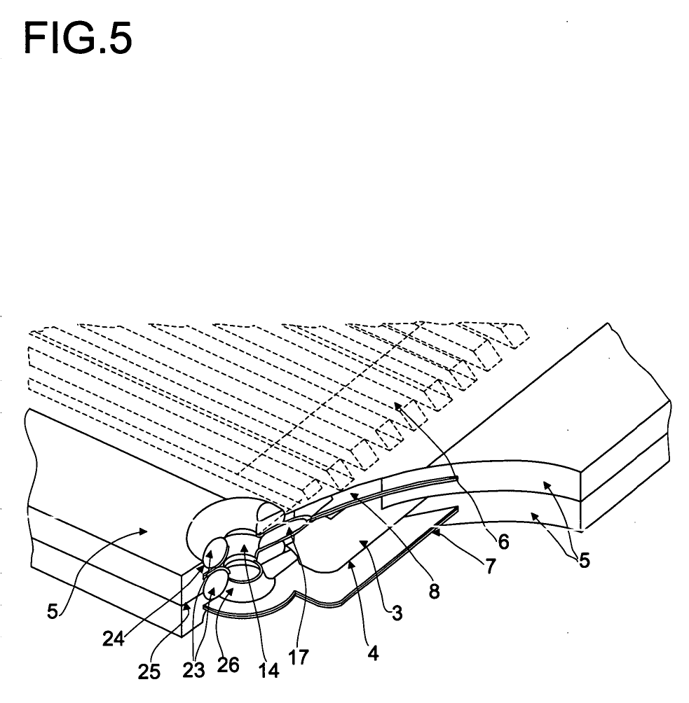

FIG. 5 shows the section through a fuel cell module according to the invention, according to FIG. 4,

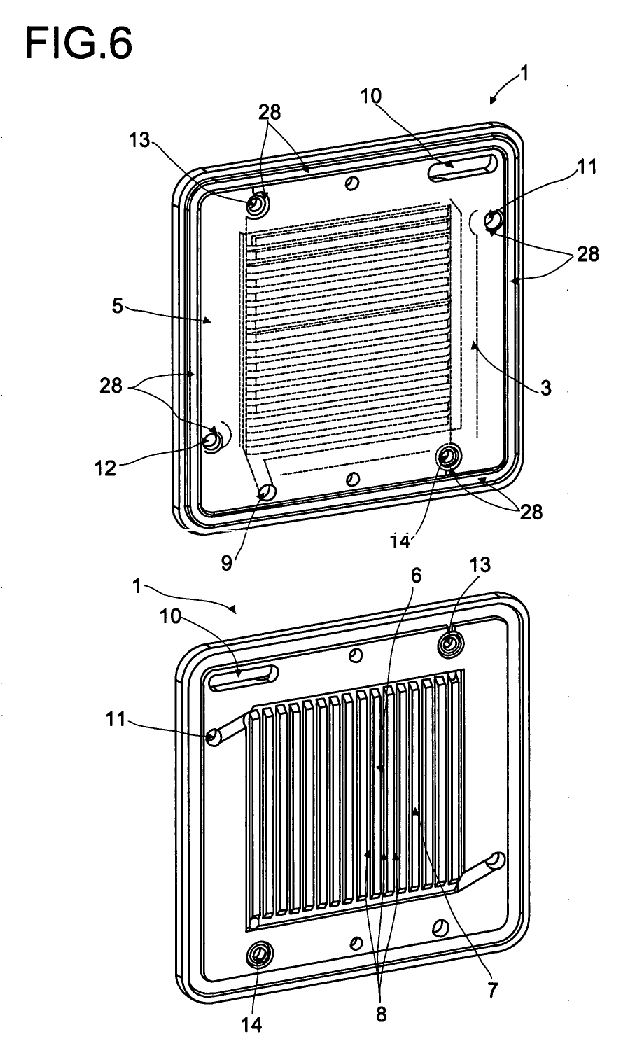

FIG. 6 shows the anode side and the cathode side of a further embodiment of a fuel cell module according to the invention comprising an elastomer seal overlapping the MEA,

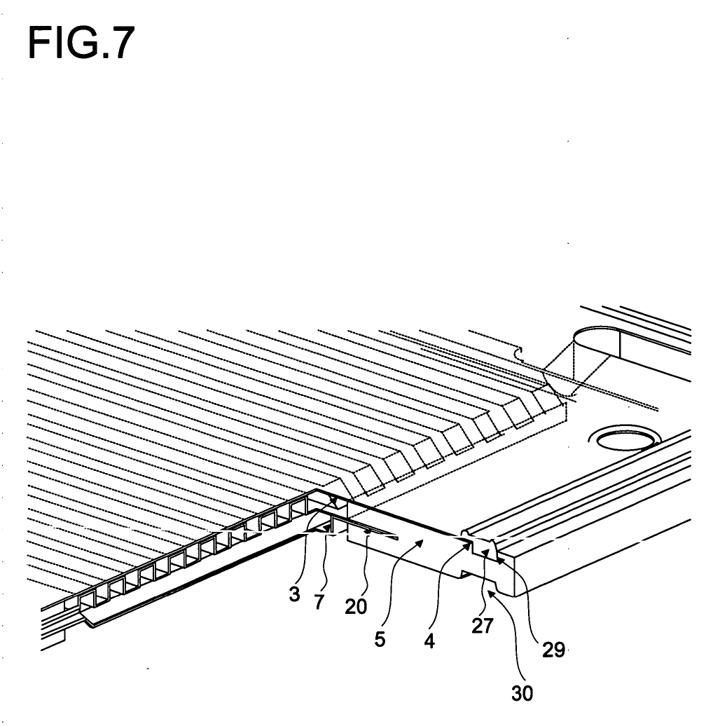

FIG. 7 shows a section through the fuel cell module according to FIG. 6 in the area of the elastomer seal, and

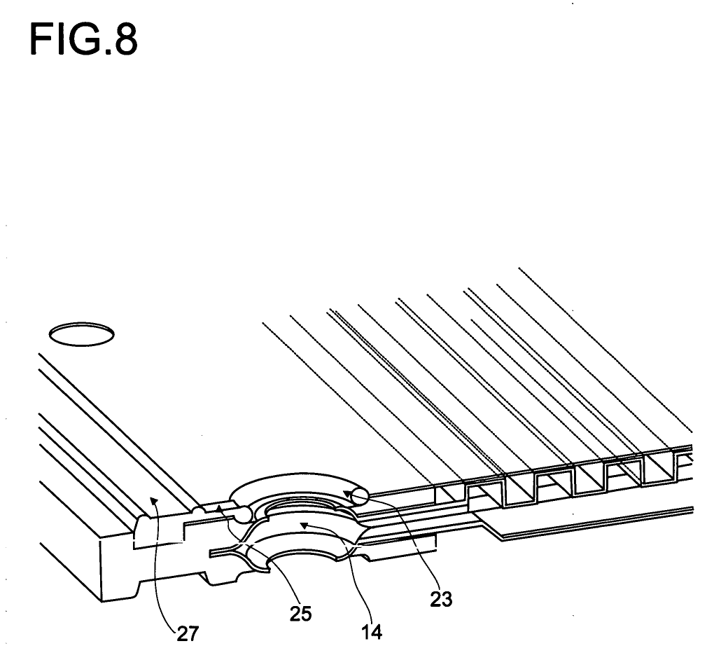

FIG. 8 shows a section through the fuel cell module according to FIG. 6 in the area of the coolant channel.

FIG. 1 shows an embodiment of a fuel cell module according to the invention, in which the membrane-electrode assembly is welded, on its anode side, to the bipolar plate frame.

The anode side is shown in the left-hand side of the figure and the cathode side is shown on the right-hand side.

The fuel cell module 1 comprises a bipolar plate 2 and a membrane-electrode assembly (MEA) 3, which are joined to one another. The edge 4 of the MEA 3, said edge being formed in particular by the edge of the polymer-electrolyte membrane, overlaps the frame 5 of the bipolar plate 2. Located in this overlap region is a weld by means of which the MEA 3 is affixed to the frame 5. This weld was preferably produced by laser welding. Located in the inner bipolar plate region 6 is a metal insert 7 having channels 8 for distributing the gases. The interior of the metal insert 7 contains further channels (not visible in this figure) for transporting coolant. The bipolar plate frame 5 has channels for supplying and discharging liquids and gases. Via a first inlet 9, H₂ can be fed in, for example. The hydrogen is then distributed via the channels 8 in the inner bipolar plate region 6, and the hydrogen not consumed in the fuel cell reaction is in turn discharged via the first outlet 10. Likewise, a second inlet 11 and outlet 12 exist for the other gas taking part in the fuel cell reaction (e.g. O₂), which is passed via the channels 8 on the cathode side along the surface of the inner bipolar plate region 6. In addition, the frame 5 comprises further channels 13, 14 for a coolant which flows through the interior of the metal insert 7.

FIG. 2 shows metal sheets which can be used as a metal insert in the inner bipolar plate region of the fuel cell module according to the invention.

In this figure, the metal insert 7 is shown as broken down into two halves 15, 16. To fabricate the metal insert, the two halves 15, 16 are folded together and are joined by a joining technique such as pressing, welding or soldering, thus ensuring good electrical contact between the two halves 15, 16. Each half 15, 16 has channels 8 which are designed to supply the cell faces with the reactants taking part in the fuel cell reaction. In the assembled state, they envelop a largely closed space in which half-shell elements 17, 18 (shown only from the outside in FIG. 2) are provided to establish a connection to the frame of the bipolar plate. Via the frame and the half-shell elements 17, 18 coolant is introduced into the enclosed space present in the metal insert and is removed therefrom.

FIG. 3 shows a section through a fuel cell module according to the invention.

The section through the center of the fuel cell module 1 visualizes, in the metal insert 7, the coolant channels 19 enclosed thereby. They are connected, inter alia, to the channel 13, present in frame 5, for coolant, via which channel they are supplied with the coolant.

The frame 5 is a one-piece injection molding formed by injection around the metal insert 7 in its edge zone 20.

The MEA 3, in the region of its edge 4 overlaps the frame 5 without, however, covering it completely. In the region of said edge 4, the MEA 3, in particular the polymer-electrolyte membrane present without additional layers in its edge zone 4, is tightly welded onto the frame 5. This was preferably effected by laser welding.

In addition, that portion of the frame 5 which is shown in FIG. 3 has a first inlet 9 for a reactant gas (e.g. H₂), said inlet leading to one side of the metal insert 7, and an outlet 12 for the other reactant gas (e.g. O₂), said outlet being connected to the other side of the metal insert 7.

FIG. 4 shows a portion of a fuel cell stack according to the invention which is formed from two fuel cell modules according to the invention.

In each case, one bipolar plate 2 in the stack is in electrical contact, with one of its surfaces, with the anode of one fuel cell of the stack, while the opposite surface is in contact with the cathode of the adjacent cell. FIG. 4, on the left, shows the anode side of a bipolar plate and, on the right, the cathode side of the next bipolar plate in the stack. Visible on the anode side are inlet and outlet 9, 10 for a gas, inlet and outlet 11, 12 for a further gas, the channels for coolant 14, 15 and the MEA 3 welded, in its edge zone 4, to the frame 5. On the cathode side, inlets and outlets 9, 10, 11, 12 and channels 14, 15 are likewise formed. Also shown is the back of the metal insert 7 surrounded by the frame 5 in the inner bipolar plate region 6, said insert having channels 8 for distributing the gas flowing in via the inlet 11. The two fuel cell modules 21, 22 according to the invention are compression-bonded to one another via the frames 5 of the two bipolar plates.

FIG. 5 shows a section through two fuel cell modules according to the invention linked to one another to form a fuel cell stack.

The section is situated in the area of a channel 14 for a coolant. In this area, seals 23 encompassing the channel 14 are seated into the frame 5. These annular seals 23 are accommodated by annular grooves 24 in the two frames 5, attached to one another, of the two bipolar plates. This results in a liquid-tight channel 14 for the coolant in the fuel cell stack, said channel extending axially through the entire fuel cell stack and having one half-shell element 17 branching off therefrom in each fuel cell module 1, said elements supplying the inner bipolar plate region 6 with coolant. The annular seal 23 preferably is an elastomer seal which was injection-molded onto the preferably thermoplastic frame 5. In addition, a sealing fin 25 each seals two frames 5 with respect to one another.

The membrane-electrode assembly 3 extends over the entire inner bipolar plate region 6 and between two frames 5 in each case, being welded in its edge zone 4 to one frame 5. The metal insert 7, in the area of the annular seal 23, has an annular bulge 26 sealingly fitted by the seal 23. The metal insert 7 further contains channels 8 for gases.

FIG. 6 shows a further embodiment of a fuel cell module according to the invention comprising an elastomer seal overlapping the membrane-electrode assembly.

The left-hand halt of the figure shows the anode side and the right-hand half the cathode side of the fuel cell module 1. The fuel cell module 1 has a frame 5 and an inner bipolar plate region 6. The frame 5 has inlets and outlets 9, 10, 11, 12 for the gases taking part in the fuel cell reaction, and channels 13, 14 for a coolant. Disposed in the inner bipolar plate region 6 is a metal insert 7 having bilaterally arranged channels 8 for distributing the gases on the surface and inner channels (not visible) for transporting coolant.

The MEA 3 covers the entire anode side and extends as far as the inner rim of the groove 29. The MEA 3 is positioned on the frame 5 by an elastomer seal 27 which is bonded to the frame by virtue of material or mechanically locked thereonto and which overlaps the edge of the MEA 3. In addition to the elastomer seal 27, further seals 28 are disposed on the frame which encompass all the inlets and outlets 9, 10, 11, 12 and channels 13, 14 on the anode side.

FIG. 7 shows a section through the fuel cell module according to FIG. 6 in the area of the elastomer seal.

On its one side (in this case at the top), the frame 5 has, in its edge zone, a circumferential groove 29 in which the elastomer 27 is seated over parts of its width. By a further part of its width, the elastomer seal 27 overlaps the MEA 3 laid onto the anode side of the bipolar plate. As a result, the MEA 3 is affixed to the frame 5 of the bipolar plate. In this arrangement, the elastomer seal 27 preferably rests solely on the edge 4 of the MEA 3, more permanent positioning being achieved only during assembly of a fuel cell stack by the elastomer seal 27 being pressed against the MEA 3 by the next bipolar plate frame 5 in the stack. Preferably, the elastomer seal 27 sealingly engages, during assembly of a fuel cell stack into a suitably shaped circumferential groove 30 which in this case is present on the cathode side in the frame 5 of the next bipolar plate. This, on the one hand, results in stable positioning of the MEA 3 on the anode side of the bipolar plate and, on the other hand, in reliable sealing of the respective fuel cell modules with respect to one another.

The frame 5 is additionally joined to the edge zone 20 of a metal insert 7 which forms the inner bipolar plate region and which is likewise covered by the MEA 3 affixed to the frame 5.

FIG. 8 shows a section through the fuel cell module according to FIG. 6 in the area of the coolant channel.

In addition to the elastomer seal 27, further seals molded onto the frame 5 serve to effect sealing in the fuel cell stack. The coolant channel 14 is encompassed, for example, by an annular seal 23 which is linked to the elastomer seal 27 via a sealing fin 25.

### List of Reference Symbols

1 Fuel cell module

2 Bipolar plate

3 Membrane-electrode assembly

4 Edge of membrane-electrode assembly

5 Frame of bipolar plate

6 Inner bipolar plate region

7 Metal insert

8 Channels

9 First inlet (H₂)

10 First outlet (H₂)

11 Second inlet (O₂)

12 Second outlet (O₂)

13 First channel for coolant

14 Second channel for coolant

15 First half of the metal insert

16 Second half of the metal insert

17 First half-shell element

18 Second half-shell element

19 Coolant channels

20 Edge zone of the metal insert

21 First fuel cell module

22 Second fuel cell module

23 Annular seals

24 Annular groove

25 Sealing fin

26 Annular bulge

27 Elastomer seal

28 Seals

29 First circumferential groove

30 Second circumferential groove

We claim:

1. A fuel cell module for PEM fuel cell stacks comprising a bipolar plate and a membrane-electrode assembly (MEA), wherein the bipolar plate includes a circumferential frame made of an electrically non-conductive material and further includes an electrically conductive inner bipolar plate region which is enclosed by the frame and comprises channels for gases and, if required, for coolants, and wherein the MEA, which comprises a polymer-electrolyte membrane is fixed on the anode side to the frame of the bipolar plate by means of a weld or by a circumferential elastomer seal partially overlapping the MEA.

2. A fuel cell module as claimed in claim 1 wherein the inner bipolar plate region includes metal sheets which have structures for the purpose of gas distribution and cooling.

3. A fuel cell module as claimed in claim 1, wherein the inner bipolar plate region includes an electrically conductive polymer.

4. A fuel cell module as claimed in claim 1, wherein the frame is integrally molded onto and around the inner bipolar plate region.

5. A fuel cell module as claimed in claim 1, wherein the nonconductive material is an electrically nonconductive thermoplastic or thermosetting plastic, either of which may be reinforced.

6. A fuel cell module as claimed in claim 1, wherein the non-conductive material is a polymer from the group consisting of PPS, LCP, POM. PAEK, PA, PBT, PPO, PP or PES.

7. A fuel cell module as claimed in claim 1, wherein the frame includes supply channels and distribution channels for liquids and gases.

8. A method of fabricating a fuel cell module as claimed in claim 1, wherein the MEA is joined to the frame by means of a welding technique.

9. A method as claimed in claim 8, wherein the MEA is joined to the frame by laser welding.

10. A method of fabricating a fuel cell module as claimed in claim 1, wherein the elastomer seal is molded onto the frame by an elastomer being injection-molded in such a manner that said elastomer seal is bonded by virtue of material to the frame or mechanically interlocked therewith and partially overlaps the MEA laid onto the frame.

11. A fuel cell stack comprising at least two fuel cell modules as claimed in claim 1, wherein the fuel cell modules are linked to one another via the frames and the fuel cell modules are sealed with respect to one another in a gastight manner via the elastomer seal and/or additional sealing elements disposed on the frame.
